(19) United States
(12) Patent Application Publication
(10) Pub. No.: US 2020/0195447 A1
(43) Pub. Date: Jun. 18, 2020

(54) COMMUNICATION METHOD OF CLIENT DEVICE, ISSUING DEVICE AND SERVER

(71) Applicant: ICTK HOLDINGS CO., LTD., Seongnam-si (KR)

(72) Inventor: Won Seok SHIN, Yongin-si (KR)

(21) Appl. No.: 16/672,776

(22) Filed: Nov. 4, 2019

(30) Foreign Application Priority Data
Dec. 13, 2018 (KR) 10-2018-0160962
May 10, 2019 (KR) 10-2019-0054848

(51) Int. Cl. H04L 9/32; H04L 29/06

(52) U.S. Cl. CPC H04L 9/3278; H04L 9/3268; H04L 63/062; H04L 63/164; H04L 63/0823; H04L 9/3247

(57) ABSTRACT

Disclosed is a communication method of a client device, an issuing device, and a server. The client device generates a public key and a private key of the client device using a physical unclonable function (PUF) value in a PUF chip included in the client device, transmits the public key of the client device to an issuing device, and receives a certificate from the issuing device. The certificate is generated in the issuing device based on CERT_TBS generated in the issuing device and SIGNATURE_BY_CA generated in a certification authority (CA) device.

### CROSS-REFERENCE TO RELATED APPLICATIONS

This application claims the benefit under 35 U.S.C. § 119(a) and 37 CFR § 1.55 to Korean Patent Application No. 10-2018-0160962 filed on Dec. 13, 2018 and Korean Patent Application No. 10-2019-0054848 filed on May 10, 2019, the entire contents of which is incorporated herein by reference.

### BACKGROUND OF THE INVENTION

### Field of the Invention

One or more example embodiments relate to a communication method of a client device, an issuing device, and a server and, more particularly, to a communication method for verifying a client on a transport layer security (TLS) using a physically unclonable function (PUF) key.

### Description of the Related Technology

One of the most important aspects of modern security is key leakage prevention. When a client device stores a private key, there is a risk of leakage of the private key. The leakage of the private key can eventually lead to a dangerous situation where the security of the entity itself may collapse. Therefore, high security is required for private key storage.

### SUMMARY

According to an aspect, there is provided a communication method of a client device, the method including generating a public key and a private key of the client device using a physical unclonable function (PUF) value in a PUF chip included in the client device, transmitting the public key of the client device to an issuing device, and receiving a certificate from the issuing device, wherein the certificate is generated in the issuing device based on CERT_TBS generated in the issuing device and SIGNATURE_BY_CA generated in a certification authority (CA) device.

The CERT_TBS may be generated in the issuing device based on contents associated with a certificate issuance and the public key of the client device.

The SIGNATURE_BY_CA may be a result value obtained by signing for the CERT_TBS using a private key of the CA device.

The communication method may further include storing the certificate in the PUF chip.

The private key may not be transmitted external to the PUF chip.

The communication method may further include transmitting the certificate to a server to communicate with. The certificate may be verified using a private key of the CA device and the CERT_TBS acquired from the certificate in the server.

The communication method may further include performing signing based on the private key of the client device for ACCUM_HANDSHAKE_MSGS generated by collecting a cumulative handshake message and transmitting a result of the signing to a server to communicate with. The result of the signing may be verified based on a public key of the client device parsed from the certificate and the ACCUM_HANDSHAKE_MSGS generated by collecting the cumulative handshake message in the server.

According to another aspect, there is also provided a communication method of an issuing device, the method including receiving, from a client device including a PUF chip, a public key of the client device generated using a PUF value, generating CERT_TBS based on contents associated with a certificate issuance and the public key of the client device, transmitting the CERT_TBS to a CA device, generating a certificate based on the CERT_TBS and SIGNATURE_BY_CA received from the CA device, and transmitting the certificate to the client device.

According to another aspect, there is also provided a communication method of a server, the method including receiving a certificate from a client device to communicate with, acquiring CERT_TBS for the client device and a public key of a CA device by parsing the certificate, and verifying the certificate using the CERT_TBS and the public key of the CA device.

The communication method may further include receiving a result of signing performed based on a private key of the client device for ACCUM_HANDSHAKE_MSGS generated by collecting a cumulative handshake message in the client device, and verifying the result of the signing based on a public key of the client device parsed from the certificate and ACCUM_HANDSHAKE_MSGS generated by collecting a cumulative handshake message in the server.

According to another aspect, there is also provided a communication method of a client device, the method including generating a public key and a private key of the client device using a PUF value in a PUF chip included in the client device, transmitting the public key of the client device to an issuing device, performing signing based on the private key of the client device for CSR_TBS received from the issuing device, transmitting a result of the signing to the issuing device, and receiving a certificate from a CA device.

The CSR_TBS may be generated in the issuing device based on contents associated with a certificate issuance and the public key of the client device.

A certificate signing request (CSR) may be generated based on the CSR_TBS and the result of the signing and transmitted to the CA device.

The communication method may further include storing the certificate in the PUF chip.

The private key may not be transmitted external to the PUF chip.

According to another aspect, there is also provided a communication method of an issuing device, the method including receiving, from a client device including a PUF chip, a public key of the client device generated using a PUF value, generating CSR_TBS based on contents associated with a certificate issuance and the public key of the client device, transmitting the CSR_TBS to the client device, receiving a result of signing performed based on a private key of the client device for the CSR_TBS from the client device, and transmitting, to a CA device, a CSR generated based on the CSR_TBS and the result of the signing.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a physically unclonable function (PUF) chip according to an example embodiment;

FIGS. 2 through 4 are diagrams illustrating examples of provisioning through certificate signing request (CSR) generation according to an example embodiment;

FIGS. 5 through 7 are diagrams illustrating examples of provisioning through TBS content direct signing according to an example embodiment;

FIG. 8 is a diagram illustrating a handshake according to an example embodiment;

FIGS. 9 through 13 are diagrams illustrating examples of a communication method according to an example embodiment; and

FIG. 14 is a diagram illustrating a communication apparatus according to an example embodiment.

### DETAILED DESCRIPTION OF CERTAIN INVENTIVE EMBODIMENTS

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

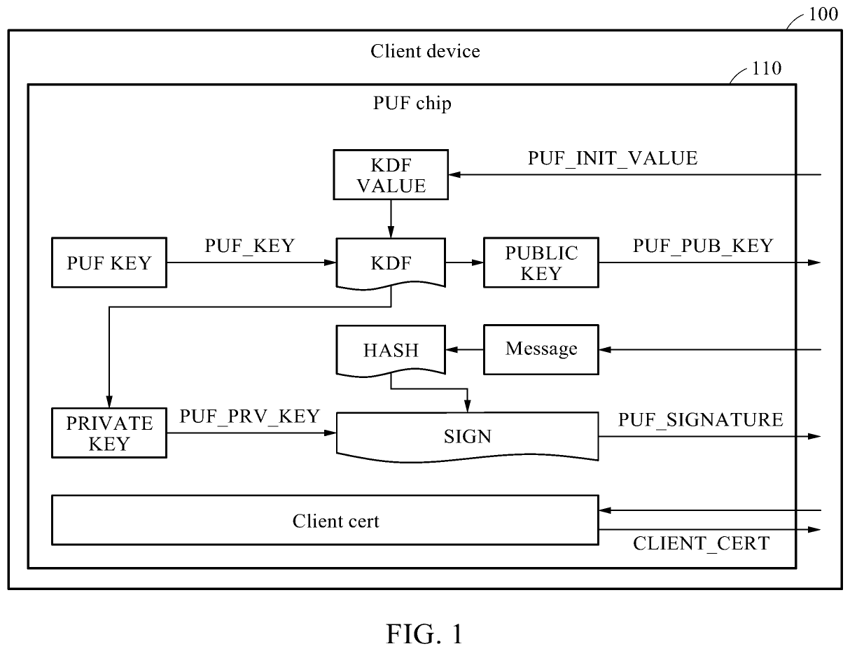

FIG. 1 is a diagram illustrating a physically unclonable function (PUF) chip according to an example embodiment.

A PUF may be a technology that generates and utilizes a security key using a difference in microstructure of a semiconductor produced in the same manufacturing process. The microstructure of the semiconductor may be generated randomly in itself without applying an external random number generator (RNG), and may also be referred to as a “semiconductor chip fingerprint” because it has uniqueness like a human fingerprint.

The PUF may be characterized in that a replication is not possible due to a characteristic of the randomly occurring semiconductor microstructure. Since the difference in microstructure is used as a key value, the key value may not be stored in a device and thus, protected from being hacked. Also, a non-repudiation function may be enhanced through a digital signature structure using the unique key value so as to be applied to a device authentication.

Such PUF value may be expressed by n bytes and used to generate a new key value based on a key derivation function (KDF).

Referring to FIG. 1, the client device 100 may include the PUF chip 110.

The PUF chip 110 may include at least one PUF value. The PUF key may be present in the PUF chip 110. By using the PUF key, a public key and a private key may be generated in a KDF. The private key may be designed not to be exposed to an outside of the PUF chip 110 and designed such that digital signing is performed in the PUF chip. Also, in the PUF chip 110, at least one certificate may be stored in an internal memory storage.

When using the PUF key, the public key may be extracted externally to the PUF chip 110, but the private key is not extracted. Thus, a signature value may be obtained using a signature function in the PUF chip 110. Through this, a leakage of the private key may be prevented, which may enhance a security.

### PUF Key Generating Process

A communication method may authenticate a client on a TKS using a PUF key. For example, the communication method may be for a key exchange as a client through the PUF chip in the 1.2 protocol in TLS communication. The TLS may be designed to prevent eavesdropping, interfering, and forgery while a client/server application program performs communication in a network. The TLS may maintain an authentication and communication confidentiality of a final stage through encryption.

In order to use the PUF chip in the TLS, an asymmetric key via the PUF chip may be generated in any case. Hereinafter, a process for generating the asymmetric key will be described.

A PUF initialization may be performed. PUF_INIT_VALUE may be input from outside and transmitted to a KDF as a factor. In this example, the PUF_INIT_VALUE may be an external set value (or SEED value) for performing the KDF of the PUF chip 110.

Also, the asymmetric key may be generated.

KDF(PUF_INIT_VALUE, PUF_KEY)

==>PUF_PRV_KEY, PUF_PUB_KEY

In other words, based on the PUF_INIT_VALUE and a PUF_KEY which is a unique key value in the PUF chip 110, a private key PUF_PRV_KEY and a public key PUF_PUB_KEY occurring based on the PUF value may be generated.

Also, the generated public key may be transmitted external to the PUF chip 110. In response to the PUF_PUB_KEY being transmitted to an outside, CERT or a certificate signing request (CSR) may be generated. Here, the CERT may indicate a certificate and the CSR may indicate a certificate signing request value.

### PUF Signing Process

Since the PUF_PRV_KEY is present in the PUF chip 110 and not exposed to an outside, the corresponding function may be performed through signature value calculation.

First, a message may be input from an outside. The message may be, for example, a hashed value or a non-hashed value.

In addition, a signature value may be calculated using the PUF_PRV_KEY.

SIGN(PUF_PRV_KEY, CSR_TBS)

==>PUF_SIGNATURE

In other words, signing may be performed based on the PUF_PRV_KEY and the CSR_TBS, so that PUF_SIGNATURE is generated as a result. Here, the PUF_SIGNATURE may indicate a signature value calculated using the PUF_PRV_KEY and the CSR_TBS may indicate a signing target value (to be signed) of the CSR.

Also, the calculated signature value may be transmitted to an outside of the PUF chip 110. Such signature may be used when creating a signature value to be input to the CSR during provisioning, or used when writing a signature value of “Client Certificate Verify” during HANDSHAKE.

Provisioning in which a certificate is issued may be performed through CSR generation or through TBS content direct signing, and related description will be made with reference to the accompanying drawings.

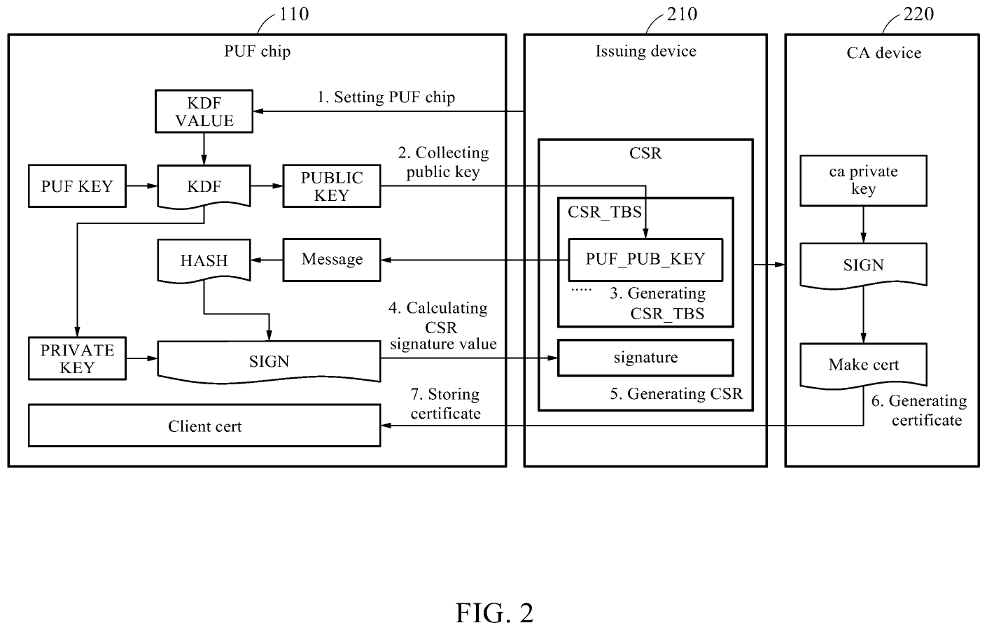

FIGS. 2 through 4 are diagrams illustrating examples of provisioning through certificate signing request (CSR) generation according to an example embodiment.

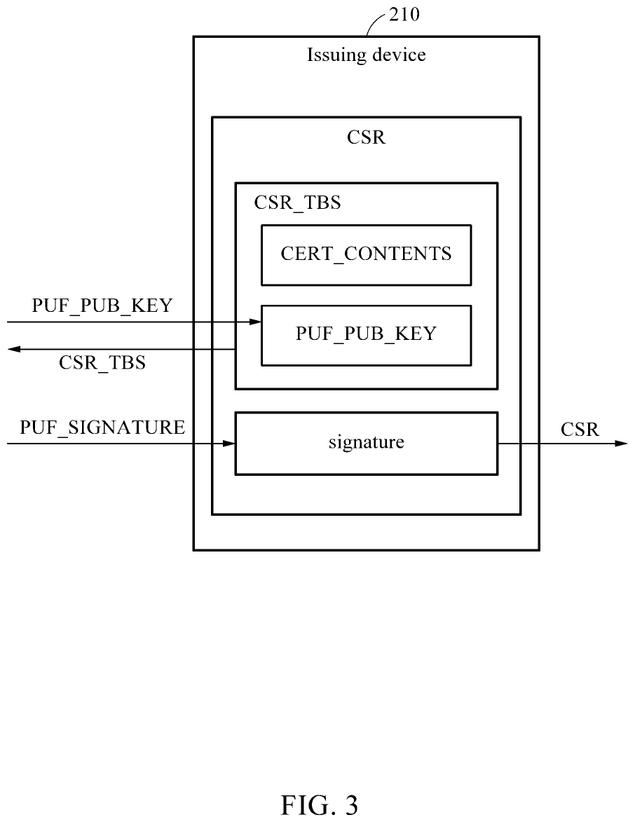

FIG. 3 illustrates a PUF chip 110, an issuing device 210, and a CA device 220. Here, the issuing device 210 may be a device of an issuer and the CA device 220 may be a device of a certification authority.

Provisioning through CSR generation may employ a typical certificate issuing system. The typical certificate system may generate a CSR using a private key generated by itself, while the PUF chip 110 does not open a private key. Thus, a CSR file may be generated by combining signature values calculated directly in the PUF chip 110.

First, the PUF chip 110 may be set. For example, an initial setting for prior chip operation and PUF_INIT_VALUE may be input to the PUF chip 110.

Second, a public key may be collected. For example, the public key may be generated based on the PUF_INIT_VALUE and the PUF value in the PUF chip 110.

Third, CSR_TBS may be generated. For example, the CSR_TBS may be generated based on contents associated with a certificate issuance and the public key generated in the PUF chip 110. In this example, the contents associated with the certificate issuance may include information on a type of an information digital signature algorithm included in the certificate. Also, the CSR_TBS may be transmitted from the issuing device 210 to the PUF chip 110 as a message.

Fourth, a CSR signature value may be calculated. The CSR_TBS transmitted to the PUF chip 110 as a message may be hashed, and signing may be performed by a private key generated in the PUF chip 110 based on a PUF value. A signing result may be transmitted from the PUF chip 110 to the issuing device 210 again. In this disclosure, the terms “signing result” and “signature value” may be interchangeably used for ease of description.

Fifth, a CSR may be generated by merging the CSR_TBS and the signing result. The generated CSR may be transmitted from the issuing device 210 to the CA device 220 corresponding to an external authentication authority.

Sixth, a certificate may be generated. The CA device 220 may determine an authentication entity and the like, and generate a TBS type based on contents included in a body of the CSR, a serial number, and issuer information of a CA certificate issued and/or managed by the corresponding authority. Also, the CA device 220 may sign for the corresponding type using a private key of the CA certificate and merge the signing result and the TBS, thereby generating the certificate. The generated certificate may be transmitted from the CA device 220 to the PUF chip 110. Here, the private key of the CA authenticate may also be referred to as a private key of the CA device 220 for ease of description.

Seventh, the certificate may be stored in the PUF chip 110. Depending on an example, the certificate may be stored external to the PUF chip 110.

FIG. 3 illustrates a CSR generating process of an issuing device 210.

The issuing device 210 may receive a public key generated in a PUF chip based on a PUF value.

Also, the issuing device 210 may generate CSR_TBS by combining the public key and contents associated with a certificate issuance. Here, the contents associated with the certificate issuance may indicate contents required for the certificate issuance.

MAKE_CSR_TBS(CERT_CONTENTS, PUF_PUB_KEY)

==>CSR_TBS

In the above, MAKE_CSR_TBS may indicate a function for generating CSR_TBS and CERT_CONTENTS may indicate the contents associated with the certificate issuance. The issuing device 210 may transmit the generated CSR_TBS to the PUF chip 110.

Also, the issuing device 210 may receive a signing result of the CSR_TBS from the PUF chip 110. In this instance, the signing result of the CSR_TBS may be acquired in the PUF chip 110 as shown below.

SIGN(PUF_PRV_KEY, CSR_TBS)

==>PUF_SIGNATURE

In the above, PUF_SIGNATURE may indicate a result of signing using PUF_PRV_KEY. The PUF chip 110 may transmit the PUF_SIGNATURE to the issuing device 210.

The issuing device 210 may generate a CSR based on the signing result received from the PUF chip 110 and the CSR_TBS.

MAKE_CSR(CSR_TBS, PUF_SIGNATURE)

==>CSR

The issuing device 210 may transmit the CSR to the CA device.

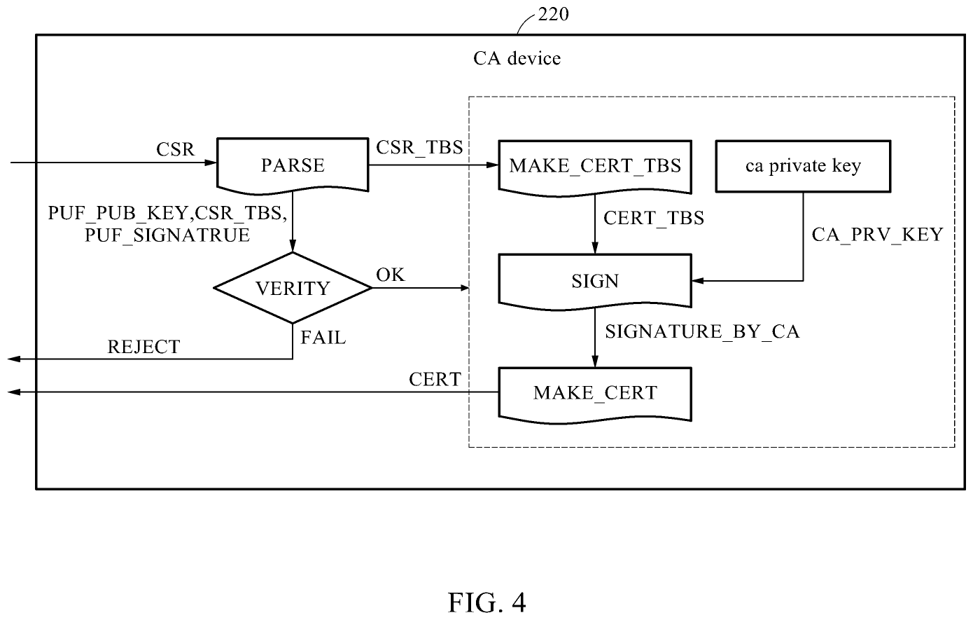

FIG. 4 illustrates a certificate generating process of the CA device 220.

The CA device 220 may receive a CSR from an issuing device.

The CA device 220 may parse the CSR to extract a public key of a PUF chip, CSR_TBS, and a signing result.

PARSE_CSR(CSR)

==>PUF_PUB_KEY, CSR_TBS, PUF_SIGNATURE

The CA device 220 may perform a signature verification based on information extracted from the CSR. When the verification fails, the CA device 220 may not allow a certificate issuance.

VERIFY(PUF_PUB_KEY, CSR_TBS, PUF_SIGNATURE)

==>VERIFY_RESULT

When the verification is successful, the CA device 220 may generate a certificate signing target value based on the CSR_TBS and a CA public key.

MAKE_CERT_TBS(CSR_TBS, ISSUER_CONTENTS)

==>CERT_TBS

In the above, CERT_TBS may indicate the certificate signing target value and ISSUER_CONTENTS may indicate issuer information.

The CA device 220 may perform signing for a certificate target value based on a private key of the CA certificate.

SIGN(CA_PRV_KEY, HASH(CERT_TBS))

==>SIGNATURE_BY_CA

In the above, SIGNATURE_BY_CA may indicate a result of signing performed using the private key of the CA certificate.

The CA device 220 may generate a certificate based on the signing result and the certificate target value.

MAKE_CERT(CERT_TBS, SIGNATURE_BY_CA)

==>CERT

The CA device 220 may transmit the certificate to the issuing device.

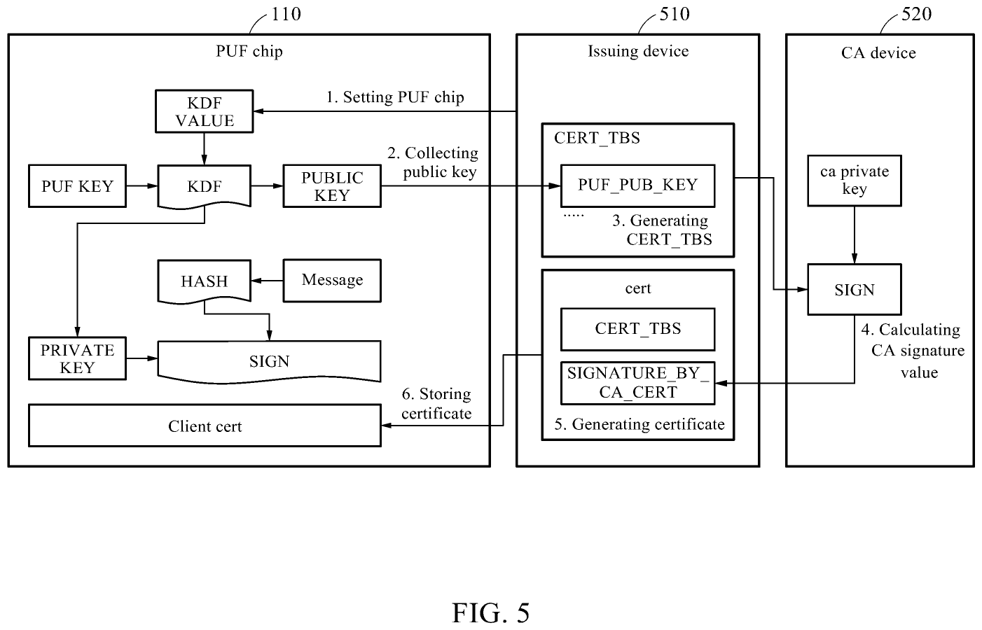

FIGS. 5 through 7 are diagrams illustrating examples of provisioning through TBS content direct signing according to an example embodiment.

FIG. 5 illustrates a PUF chip 110, an issuing device 510, and a CA device 520.

Previsioning through TBS content direct signing may generate a certificate by performing signing using a private key of the CA device 520 instead of generating a CSR unlike the above-described provisioning through CSR generation. Since the CA device 520 does not reveal the private key of the CA device 520, the signing may be performed in the CA device 520 in which the private key of the CA device 520 is securely stored.

First, the PUF chip 110 may be set. For example, an initial setting for prior chip operation and PUF_INIT_VALUE may be input to the PUF chip 110.

Second, a public key may be collected. For example, the public key may be generated based on the PUF_INIT_VALUE and the PUF value in the PUF chip 110.

Third, CERT_TBS may be generated. For example, the CERT_TBS may be generated based on contents associated with a certificate issuance and the public key generated in the PUF chip 110. In this example, the contents associated with the certificate issuance may include information on a type of an information digital signature algorithm included in the certificate, and the CERT_TBS may indicate a signature target value of the certificate. Also, the CERT_TBS may be transmitted from the issuing device 510 to the CA device 520.

Fourth, a CA signature value may be calculated. For example, signing for the CERT_TBS may be performed based on an external authentication function. A signing result may be transmitted from the CA device 520 to the issuing device 510.

Fifth, a certificate may be generated. For example, the issuing device 510 may generate the certificate by merging the CERT_TBS and the signing result received in the CA device 520. Also, the certificate may be transmitted from the issuing device 510 to the PUF chip 110.

Sixth, the certificate may be stored. For example, the certificate may be stored in the PUF chip 110. Depending on an example, the certificate may be stored external to the PUF chip 110.

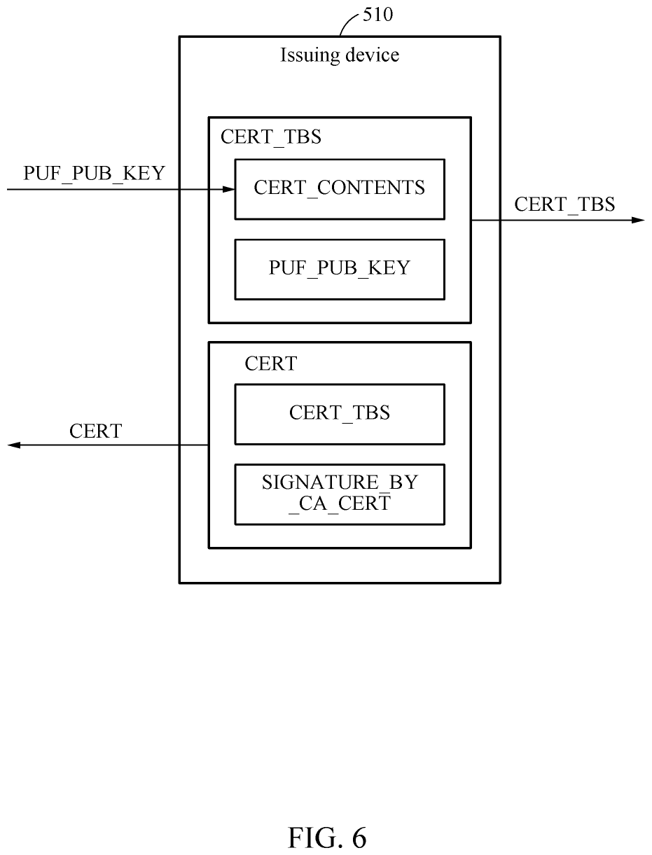

FIG. 6 illustrates a signing process of an issuing device 510.

The issuing device 510 may receive a public key generated based on a PUF value in a PUF chip.

The issuing device 510 may generate CERT_TBS by combining contents associated with a certificate issuance and the public key. Here, the contents associated with the certificate issuance may include CA issuer information and contents required for issuing a certificate.

MAKE_CERT_TBS(CERT_CONTENTS, PUF_PUB_KEY)

==>CERT_TBS

As such, CERT_TBS may be generated directly without a CSR. The issuing device 510 may transmit the generated CERT_TBS to the CA device.

The issuing device 510 may receive SIGNATURE_BY_CA which is a signing result of the CERT_TBS from a CA device corresponding to an external authentication device.

The issuing device 510 may generate a certificate based on the CERT_TBS and the signing result received from the CA device.

MAKE_CERT(CERT_TBS, SIGNATURE_BY_CA)

==>CERT

Also, the issuing device 510 may transmit the certificate to the PUF chip.

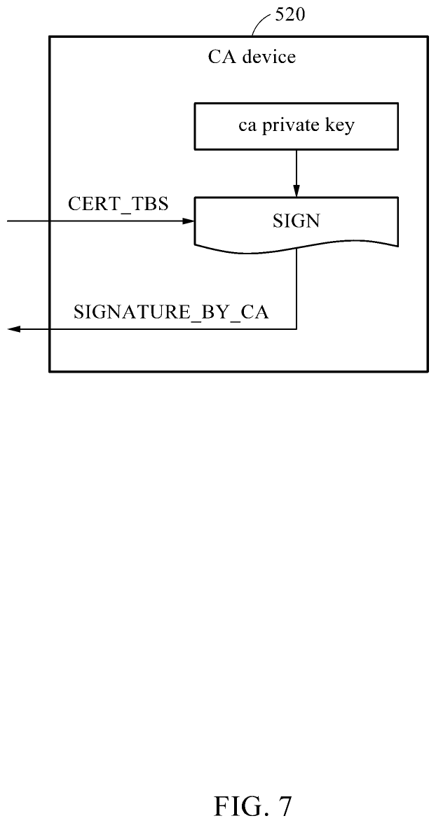

FIG. 7 illustrates a signing process of a CA device 520.

The CA device 520 may receive CERT_TBS from an issuing device.

In addition, the CA device 520 may perform signing for CERT_TBS using a private key of the CA device 520.

SIGN(CA_PRV_KEY, HASH(CERT_TBS))

==>SIGNATURE_BY_CA

Also, the CA device 520 may transmit SIGNATURE_BY_CA corresponding to a signing result to the issuing device.

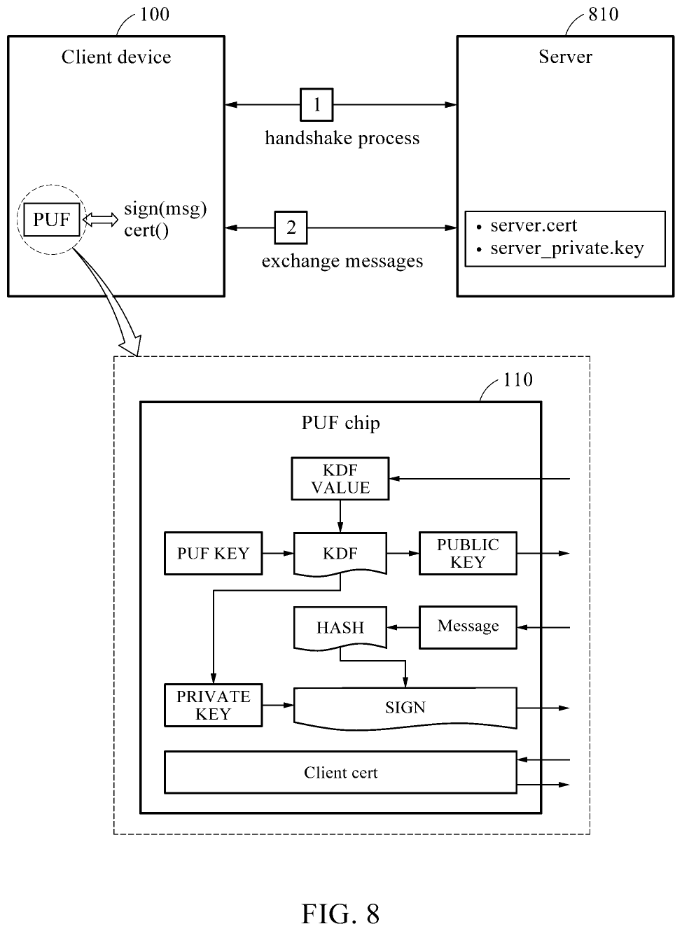

FIG. 8 is a diagram illustrating a handshake according to an example embodiment.

FIG. 8 illustrates a client device 100 and a server 810. The client device 100 and the server 810 may be devices transmitting and receiving data through TLS communication.

### Private Key and Certificate used in Handshake

After provisioning is completed, a handshake process may be performed for secure communication with an actual TLS system. During the handshake process, it is necessary to consider two steps: “Client Certificate” and “Client Certificate Verify”.

“Client Certificate” may be a process of transmitting a certificate of the client device 100 to the server 810 and verifying validities of the certificate. In this process, CLIENT_CERT stored in the PUF chip 110 may be transmitted to the server 810. Here, CLIENT_CERT may be a client certificate.

“Client Certificate Verify” may be a process of verifying a private key of the client device 100 in the server 810. In this process, a result of signing a value obtained by hashing all messages transmitted and received in the handshake process based on the PUF chip 110 may be transmitted to the server 810, so that the result of the signing is verified in the server 810. When the verification fails, the process is not performed any more.

### Process of Verifying CLIENT_CERT Certificate in the Server 810

The server 810 may retrieve a CA certificate by parsing the received CLIENT_CERT. As such, CLIENT_CERT_TBS and CA_PUB_KEY are required.

PARSE_CERT(CLIENT_CERT)

==>CLIENT_PUB_KEY, CLIENT_CERT_TBS, SIGNATURE_BY_CA

FIND_CA_CERT(CLIENT_CERT)

==>CA_CERT

PARSE_CERT(CA_CERT)

==>CA_PUB_KEY, CA_CERT_TBS, SIGNATURE

In the above, CLIENT_PUB_KEY may be a private key of the client device 100, CA_CERT may be a certificate issued in the CA device, and CA_PUB_KEY may be a private key of a CA certificate (or, a private key of the CA device).

Also, the server 810 may verify the CLIENT_CERT. When VERIFY fails, the process is not performed any more.

VERIFY(CA_PUB_KEY, CLIENT_CERT_TBS, SIGNATURE_BY_CA)

==>VERIFY_RESULT

### Process of Transmitting “Client Certificate Verify” in the Client Device 100

The client device 100 may collect handshake messages accumulated up to a preceding stage of a current stage, thereby generating ACCUM_HANDSHAKE_MSGS.

In the PUF ship 110, a signature value obtained by hashing ACCUM_HANDSHAKE_MSGS may be calculated.

SIGN(PUF_PRV_KEY, HASH(ACCUM_HANDSHAKE_MSGS))

==>CLIENT_SIGNATURE

Also, the client device 100 may transmit a signing result to the server 810.

### Verifying “Client Certificate Verify” in the Server 810

The server 810 may collect handshake messages accumulated up to a preceding stage of a current stage, thereby generating ACCUM_HANDSHAKE_MSGS.

The server 810 may acquire CLIENT_PUB_KEY by parsing the received CLIENT_CERT.

PARSE_CERT(CLIENT_CERT)

==>CLIENT_PUB_KEY, CLIENT_CERT_TBS, SIGNATURE_BY_CA

Also, the server 810 may verify a signing result based on the CLIENT_PUB_KEY and the ACCUM_HANDSHAKE_MSGS.

VERIFY(CLIENT_PUB_KEY, HASH(ACCUM_HANDSHAKE_MSGS), CLIENT_SIGNATURE)

==>VERIFY_RESULT

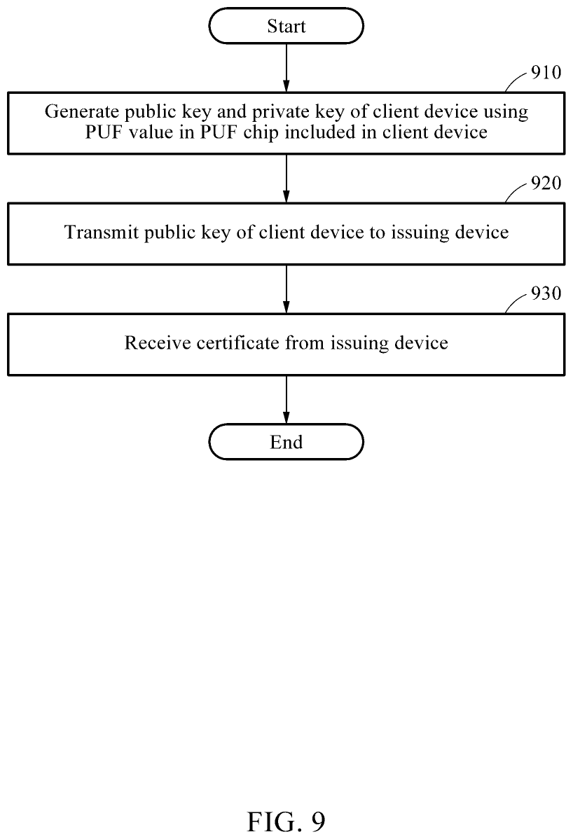

FIGS. 9 through 13 are diagrams illustrating examples of a communication method according to an example embodiment.

FIG. 9 illustrates a communication method performed by a processor of a client device according to an example embodiment. The communication method may relate to previsioning through TBS content direct signing.

In operation 910, the client device generates a public key and a private key of the client device using a PUF value in a PUF chip included in the client device. The private key is not transmitted outside the PUF chip. In other words, the private key is not shared outside the PUF chip and an access to the private key from outside the PUF chip is denied.

In operation 920, the client device transmits the public key of the client device to an issuing device.

In operation 930, the client device receives a certificate from the issuing device.

The certificate may be generated in the issuing device based on CERT_TBS generated in the issuing device and SIGNATURE_BY_CA generated in a CA device. The CERT_TBS may be generated in the issuing device based on contents associated with a certificate issuance and the public key of the client device The SIGNATURE_BY_CA may be a result value obtained by signing for the CERT_TBS using a private key of the CA device.

The client device may store the certificate in the PUF chip.

Thereafter, in a handshape process, the following operations may be performed.

The client device may transmit the certificate to a server to communicate with. The certificate may be verified using a private key of the CA device and the CERT_TBS acquired from the certificate in the server.

In addition, the client device may perform signing based on the private key of the client device for ACCUM_HANDSHAKE_MSGS generated by collecting a cumulative handshake message, and transmit a result of the signing to the server to communicate with. The result of the signing may be verified based on a public key of the client device parsed from the certificate and the ACCUM_HANDSHAKE_MSGS generated by collecting the cumulative handshake message in the server.

Since the description of FIGS. 1 through 8 are applicable to the operations of FIG. 9, repeated description will be omitted.

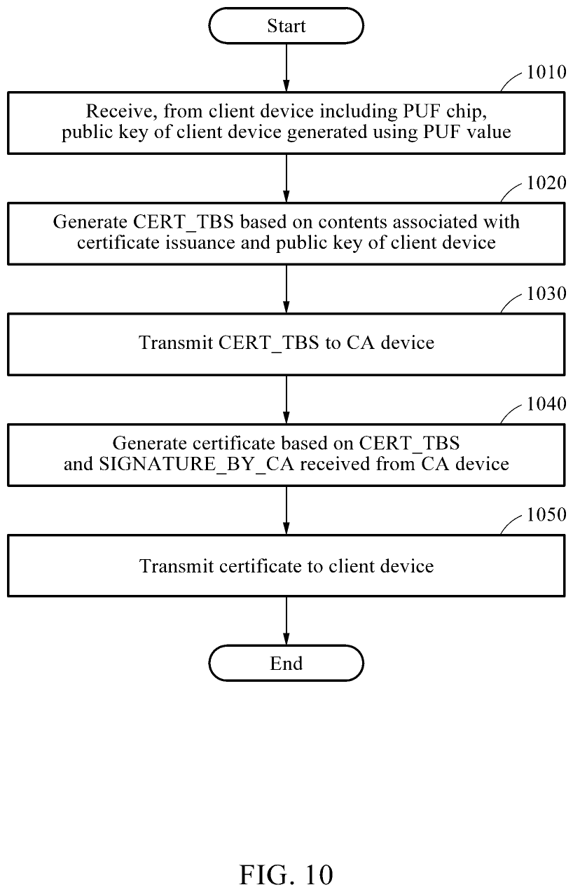

FIG. 10 illustrates a communication method performed by a processor of an issuing device according to an example embodiment. The communication method may relate to previsioning through TBS content direct signing.

In operation 1010, the issuing device receives, from a client device including a PUF chip, a public key of the client device generated using a PUF value.

In operation 1020, the issuing device generates CERT_TBS based on contents associated with a certificate issuance and the public key of the client device.

In operation 1030, the issuing device transmits the CERT_TBS to a CA device.

In operation 1040, the issuing device generates a certificate based on the CERT_TBS and SIGNATURE_BY_CA received from the CA device.

In operation 1050, the issuing device transmits the certificate to the client device.

Since the description of FIGS. 1 through 8 are applicable to the operations of FIG. 10, repeated description will be omitted.

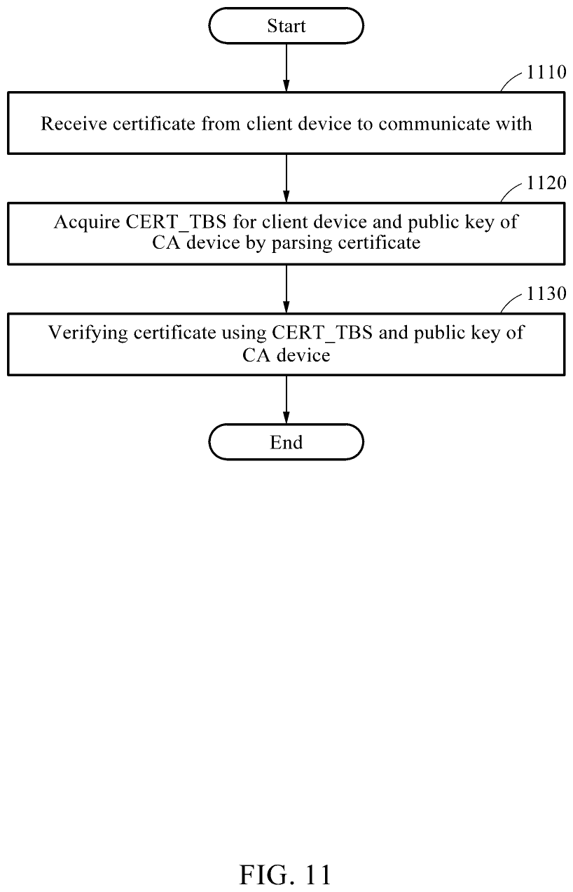

FIG. 11 illustrates a communication method performed by a processor of a server according to an example embodiment. The communication method may relate to a handshake.

In operation 1110, the server receives a certificate from a client device to communicate with.

In operation 1120, the server acquires CERT_TBS for the client device and a public key of a CA device by parsing the certificate.

In operation 1130, the server verifies the certificate using the CERT_TBS and the public key of the CA device.

In addition, the server may receive a result of signing performed based on a private key of the client device for ACCUM_HANDSHAKE_MSGS generated by collecting a cumulative handshake message in the client device, and verify the result of the signing based on a public key of the client device parsed from the certificate and ACCUM_HANDSHAKE_MSGS generated by collecting a cumulative handshake message in the server.

Since the description of FIGS. 1 through 8 are applicable to the operations of FIG. 11, repeated description will be omitted.

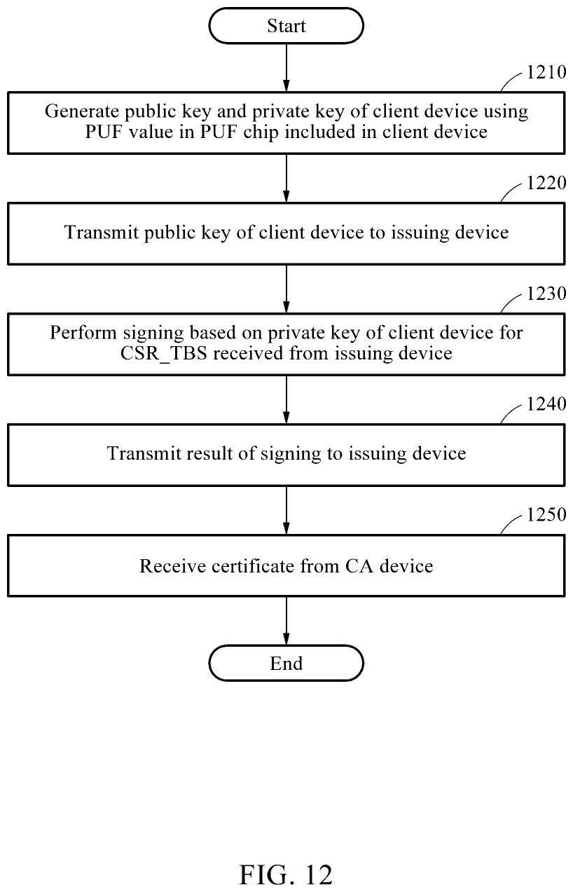

FIG. 12 illustrates a communication method performed by a processor of a client device according to an example embodiment. The communication method may relate to provisioning through CSR generation.

In operation 1210, the client device generates a public key and a private key of the client device using a PUF value in a PUF chip included in the client device. The private key is not transmitted outside the PUF chip.

In operation 1220, the client device transmits the public key of the client device to an issuing device.

In operation 1230, the client device performs signing based on the private key of the client device for CSR_TBS received from the issuing device. The CSR_TBS may be generated in the issuing device based on contents associated with a certificate issuance and the public key of the client device.

In operation 1240, the client device transmits a result of the signing to the issuing device. Based on the CSR_TBS and the result of the signing, a certificate signing request (CSR) may be generated and transmitted to the CA device.

In operation 1250, the client device receives a certificate from a CA device.

The client device may store the certificate in the PUF chip.

Since the description of FIGS. 1 through 8 are applicable to the operations of FIG. 12, repeated description will be omitted.

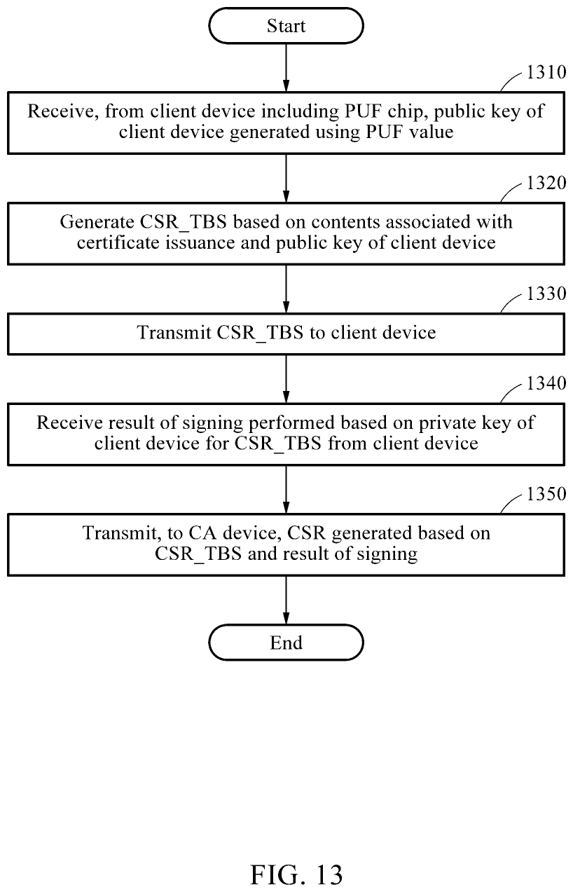

FIG. 13 illustrates a communication method performed by a processor of an issuing device according to an example embodiment. The communication method may relate to provisioning through CSR generation.

In operation 1310, the issuing device receives, from a client device including a PUF chip, a public key of the client device generated using a PUF value.

In operation 1320, the issuing device generates CSR_TBS based on contents associated with a certificate issuance and the public key of the client device.

In operation 1330, the issuing device transmits the CSR_TBS to the client device.

In operation 1340, the issuing device receives a result of signing performed based on a private key of the client device for the CSR_TBS from the client device.

In operation 1350, the issuing device transmits, to a CA device, a CSR generated based on the CSR_TBS and the result of the signing.

Since the description of FIGS. 1 through 8 are applicable to the operations of FIG. 13, repeated description will be omitted.

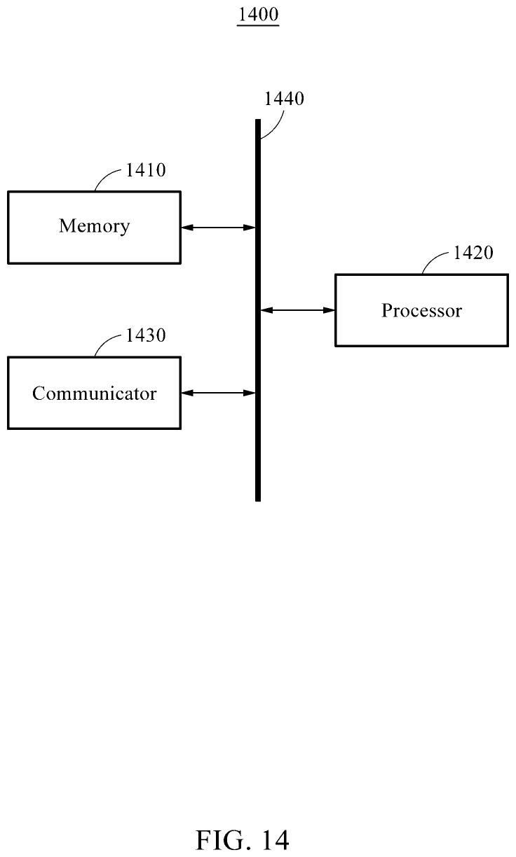

FIG. 14 is a diagram illustrating a communication apparatus according to an example embodiment.

Referring to FIG. 14, a communication apparatus 1400 may include a memory 1410, a processor 1420, and a communicator 1430. The memory 1410, the processor 1420, and the communicator 1430 may communicate with one another via a bus 1440.

The memory 1410 may include instructions to be read by a computer. The processor 1420 may perform the above-described operations in response to the instructions stored in the memory 1410 being executed in the processor 1420. The memory 1410 may be a volatile memory or a non-volatile memory.

The communication apparatus 1400 may be one of the client device, the issuing device, the CA device, and the server. Since the communication apparatus 1400 processes the above-described operations, repeated description will be omitted.

The client authentication and communication operation on the TLS using the PUF key described herein may be applied to communication for Internet of Things (IoT), vehicle control through mobile, and communication between vehicles, which may lead to increased security.

According to example embodiments, when a private key is generated based on a PUF key, an access to the private key from outside may be denied. Thus, it is possible to keep the private key in more secure state. Also, it is possible to perform communication with enhanced security by performing authentication using the PUF key on a TLS currently used in most communication networks.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method of a client device, the method comprising:
generating a public key and a private key of the client device using a physical unclonable function (PUF) value in a PUF chip included in the client device;
transmitting the public key of the client device to an issuing device; and
receiving a certificate from the issuing device,
wherein the certificate is generated in the issuing device based on CERT_TBS generated in the issuing device and SIGNATURE_BY_CA generated in a certification authority (CA) device.

2. The communication method of claim 1, wherein the CERT_TBS is generated in the issuing device based on contents associated with a certificate issuance and the public key of the client device.

3. The communication method of claim 1, wherein the SIGNATURE_BY_CA is a result value obtained by signing for the CERT_TBS using a private key of the CA device.

4. The communication method of claim 1, further comprising:
storing the certificate in the PUF chip.

5. The communication method of claim 1, wherein the private key is not transmitted external to the PUF chip.

6. The communication method of claim 1, further comprising:
transmitting the certificate to a server to communicate with,
wherein the certificate is verified using a private key of the CA device and the CERT_TBS acquired from the certificate in the server.

7. The communication method of claim 1, further comprising:
performing signing based on the private key of the client device for ACCUM_HANDSHAKE_MSGS generated by collecting a cumulative handshake message; and
transmitting a result of the signing to a server to communicate with,
wherein the result of the signing is verified based on a public key of the client device parsed from the certificate and the ACCUM_HANDSHAKE_MSGS generated by collecting the cumulative handshake message in the server.

8. A communication method of an issuing device, the method comprising:
receiving, from a client device including a physical unclonable function (PUF) chip, a public key of the client device generated using a PUF value;
generating CERT_TBS based on contents associated with a certificate issuance and the public key of the client device;
transmitting the CERT_TBS to a certification authority (CA) device;
generating a certificate based on the CERT_TBS and SIGNATURE_BY_CA received from the CA device; and
transmitting the certificate to the client device.

9. A communication method of a server, the method comprising:
receiving a certificate from a client device to communicate with;
acquiring CERT_TBS for the client device and a public key of a certification authority (CA) device by parsing the certificate; and
verifying the certificate using the CERT_TBS and the public key of the CA device.

10. The communication method of claim 9, further comprising:
receiving a result of signing performed based on a private key of the client device for ACCUM_HANDSHAKE_MSGS generated by collecting a cumulative handshake message in the client device; and
verifying the result of the signing based on a public key of the client device parsed from the certificate and ACCUM_HANDSHAKE_MSGS generated by collecting a cumulative handshake message in the server.

11. A communication method of a client device, the method comprising:
generating a public key and a private key of the client device using a physical unclonable function (PUF) value in a PUF chip included in the client device;
transmitting the public key of the client device to an issuing device;
performing signing based on the private key of the client device for CSR_TBS received from the issuing device;
transmitting a result of the signing to the issuing device; and
receiving a certificate from a certification authority (CA) device.

12. The communication method of claim 11, wherein the CSR_TBS is generated in the issuing device based on contents associated with a certificate issuance and the public key of the client device.

13. The communication method of claim 11, wherein a certificate signing request (CSR) is generated based on the CSR_TBS and the result of the signing and transmitted to the CA device.

14. The communication method of claim 11, further comprising:
storing the certificate in the PUF chip.

15. The communication method of claim 11, wherein the private key is not transmitted external to the PUF chip.

16. A communication method of an issuing device, the method comprising:
receiving, from a client device including a physical unclonable function (PUF) chip, a public key of the client device generated using a PUF value;
generating CSR_TBS based on contents associated with a certificate issuance and the public key of the client device;
transmitting the CSR_TBS to the client device;
receiving a result of signing performed based on a private key of the client device for the CSR_TBS from the client device; and
transmitting, to a certification authority (CA) device, a certificate signing request (CSR) generated based on the CSR_TBS and the result of the signing.
